(19) United States
(12) Patent Application Publication
(10) Pub. No.: US 2010/0004913 A1
(43) Pub. Date: Jan. 7, 2010

(54) WINDS ALOFT PROFILER

(75) Inventors: Robert C. Becker, Eden Prairie, MN (US); Alan G. Cornett, Andover, MN (US); David W. Meyers, Brooklyn Park, MN (US); Jerome P. Drexler, Wyoming, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/140,997

(22) Filed: Jun. 17, 2008

(51) Int. Cl. G06G 7/48; G01W 1/00; G06F 19/00

(52) U.S. Cl. 703/9; 702/3; 345/168

(57) ABSTRACT

A platform for a handheld wind profiler includes a housing containing a three-axis magnetic compass module generating a compass signal, including the orientation of the housing relative to magnetic north at a time. A two-axis inclinometer module generates a inclinometer signal including the orientation of the housing relative to a horizontal plane at the time. A GPS module generating a GPS signal indicating a time and position solution including a terrain position of the housing based upon the time. A processor receives a first velocimeter signal at the time from at least one laser Doppler velocimeter. The velocimeter signal includes a first radial velocity of a first wind-borne aerosol and a first orientation of the at least one laser Doppler velocimeter relative to the housing. The processor resolves the first velocimeter signal to determine an orientation of the at least one laser Doppler velocimeter relative to the terrain position.

### BACKGROUND OF THE INVENTION

Starting at sea level, the troposphere goes up seven miles. The bottom one third, that which is closest to us, contains 50% of all atmospheric gases. This bottom one third is the only part of the whole makeup of the atmosphere that is breathable. This is the only area where all weather takes place. Troposphere means, literally, “where the air turns over”. This is a very appropriate name, since within the troposphere, the air is in a constant up and down flow.

Also in this layer, the air is hotter closer to the earth's surface and colder air is higher up. As the hotter air rises admitting the colder air to the area near the ground, additional and complex air flows are generated. As air flows over objects close to the ground, it will roil, just like water flowing over a rock. This roiling air is known as turbulence. Turbulence is very dangerous to skydivers because if a jumper gets caught in a downward flow of air, it will accelerate the parachutist toward the ground, which can result in injury or death. Up drafts, down drafts, and winds from side to side all act to displace a skydiver or an inanimate package dropped by parachute from the intended landing zone.

Unlike water on a river, this flow is invisible, so skydivers must be aware of the objects that cause turbulence such as buildings, trees, or mountains. Depending on wind speed, turbulence can be created downwind of that obstacle at a distance of ten to twenty times the height of the obstacle.

The differential between time under the canopy and time in freefall can also make the prediction of a landing site even more difficult. A 10 mile per hour wind, for example, will drift a skydiver a half mile in a normal 3,000 foot descent under canopy. Because a skydiver in freefall is falling at speeds ranging from 120 mph and 180 mph on average, a skydiver will remain in freefall for between 45 seconds to a minute, and while displaced by winds, both of exposure time and sail area are very different than when falling under canopy.

Presently, the preferred method for measuring winds aloft is observation of the release and ascent of a balloon, requiring helium tanks, stopwatches, and a crude inclination measurement device. At that, the results are generally less exact than would be desired. Additionally, where the parachute drop is a military drop, and the landing site is in a territory that is under fire, release of a balloon gives notice to an enemy that a drop is imminent. What is needed is a method of estimating the invisible movement of air in proximity to a landing zone.

### SUMMARY OF THE INVENTION

A LIDAR works on the principle that light scattered from a moving object is frequency shifted with respect to the incident light. If a collimated beam of light of wavelength X is incident on a moving surface, the frequency or Doppler shift of the light scattered from the surface is calculable. Laser Doppler velocimetry (“LDV”) is a technique for measuring the direction and speed of fluids like air and water and is somewhat akin to using an interferometer. A beam of monochromatic laser light is sent into the flow, and particles, or motes, within the flow will reflect light with a Doppler shift corresponding to their velocities. The shift can be measured by interfering the reflected beam with the original beam, which will form a beat frequency difference proportional to the velocity.

The LDV can assess the velocity of wind by ascertaining the velocity vector of motes within the flow of wind. LDV systems provide wind speed data by measuring the Doppler shift imparted to laser light that is scattered from natural aerosols (e.g. dust, pollen, water droplets etc.) present in air. LDV systems measure the Doppler shift imparted to reflected radiation within a certain remote probe volume and can thus only acquire wind velocity data in a direction parallel to the transmitted and returned laser beam. In the case of a LDV device located on the ground, it is possible to measure the true (3D) wind velocity vector a given distance above the ground by scanning the LDV in a controlled manner; for example using a conical scan. This enables the wind vector to be intersected at a range of known angles thereby allowing the true wind velocity vector to be constructed.

The present invention comprises a system for orienting a handheld platform with respect to terrain. A GPS determines a location of the handheld device. A three-axis compass provides a tilt-independent orientation of the device with respect to the magnetic north pole. A magnetic deviation correction factor is derived from a look up table based upon the GPS determined location in order to calculate the wind velocity vector with respect to true north. At least one LDV begins a scan to develop a true 3D wind velocity vector in proximity to the landing site.

In accordance with further aspects of the invention, a platform for a handheld wind profiler includes a housing containing a three-axis magnetic compass module generating a compass signal including the orientation of the housing relative to magnetic north at a time. A two-axis inclinometer module generates an inclinometer signal including the orientation of the housing relative to a horizontal plane at the time. A GPS module generating a GPS signal indicating a time and position solution including a terrain position of the housing. A processor receives a first velocimeter signal at the time from at least one laser Doppler velocimeter. The velocimeter signal includes a first radial velocity of a first wind-borne aerosol and a first orientation of the at least one laser Doppler velocimeter relative to the housing. The processor resolves the first velocimeter signal to determine an orientation of the at least one laser Doppler velocimeter relative to the terrain position.

### BRIEF DESCRIPTION OF THE DRAWINGS

Preferred and alternative embodiments of the present invention are described in detail below with reference to the following drawings:

FIG. 1 is a block diagram of the winds aloft device;

FIG. 2 is a drawing of a preferred embodiment, and

FIG. 3 is detailed drawing of Doppler velocimeter optical subsystem.

### DETAILED DESCRIPTION OF THE INVENTION

A portable handheld Laser Doppler velocimetry (“LDV”) based profiler 3 includes a number of components along with at least one laser optics module 13. A GPS Receiver 5 may optionally include an integrated antenna or may have an external antenna. For non-limiting illustrative purposes, the GPS module is shown as complete with an integrated antenna. A 3-axis compass 7 orients the platform relative to true north. Optionally, a two-axis inclinometer 9 is included to augment the 3-axis compass to determine orientation of the platform relative to the horizon. A barometric pressure sensor 11 is used for both of determining altitude and local meteorological data. In conjunction with a temperature sensor 12, the barometric pressure sensor 11, is capable of delivering data to a processing module 15 for determination of a density of ambient air. Based upon the orientation of the LDV 3 relative to the terrain, the at least one laser optics module 13 scanning of a terrain volume can reliably occur.

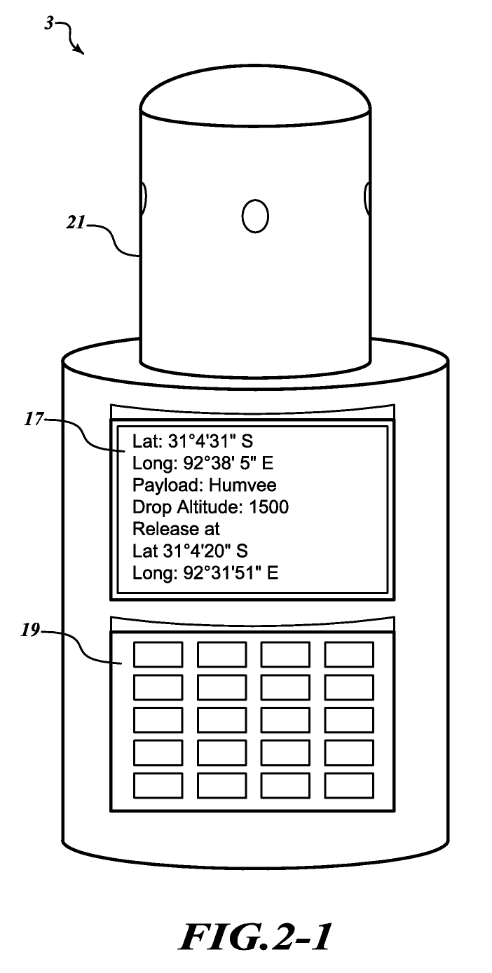

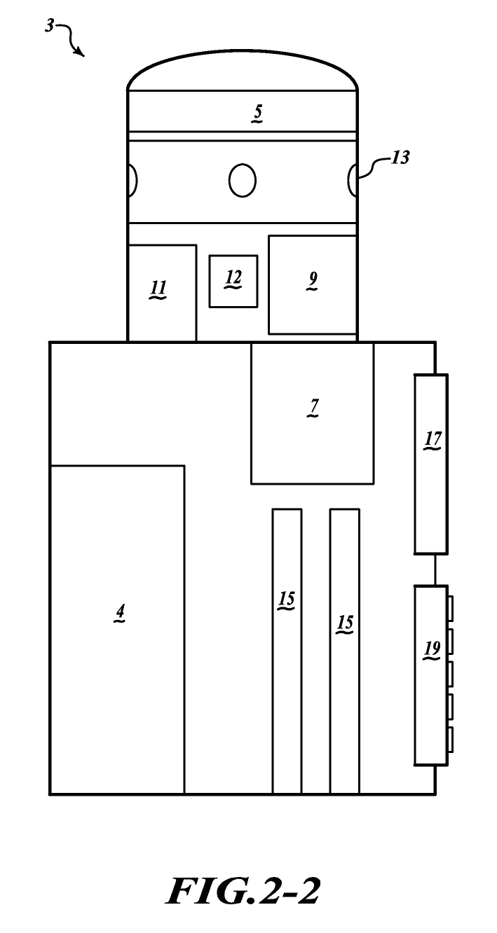

An infrastructure is necessary to make the handheld profiler 3 possible. Power is provided by a battery and power supply module (“power module”) 4 through a power bus 21 to all active components, including those listed above and others to be introduced below. A user interface includes a keyboard 19 and a graphic display 17. While a keyboard is portrayed in FIGS. 2a and 2b, the keyboard 19 might be a joystick or touchpad and switch for navigating through a menu driven interface as a user might use the same on a laptop computer. Additionally, the display 17 and the keyboard 19 need not be separate functions as a touch sensitive display may readily provide both functions as they are provided in the popular iPhone™. The several elements of the profiler 3 are coordinated by interaction with the processing module 15 which, itself includes a processor, memory (in either a RAM and ROM configuration, solid state drive serving in both capacities, or some advantageous combination), and having firmware that suitably directs the processor module 15 and controls its interactions with the remaining components of the profiler 3 by interaction through a data bus 23.

In normal operation, after the processor module 15 boots up, performs its power on self test (“POST”), and it begins processing by in turn initializing each of the GPS module 5, 3-axis compass 7, the inclinometer 9, the temperature sensor 12, the barometric sensor 11 and the laser optics module 13 as well as the display module 17 and the keyboard 19 on the data bus 23. The GPS module 5 begins to receive ephemeris from those satellites “visible” to the profiler 3. Once the GPS has received at least four distinct ephemeredes, it solves for position and time. Once an at least two dimensioned position solution is derived, the processor module 15 is able to retrieve from a look up table resident in the processor module 15, a magnetic declination corresponding to the position solution. At any point on the Earth there exists an angle between the local magnetic field—the direction the north end of a compass points—and true north, and that angle is known though varying very slowly and predictably over time. The magnetic declination in a given area will change slowly over time, possibly as much as 2-25 degrees every hundred years or so, depending upon how far from the magnetic poles it is. The declination is positive when the magnetic north is east of true north.

Magnetic declination varies both from place to place, and with the passage of time. As a traveler cruises the east coast of the United States, for example, the declination varies from 20 degrees west (in Maine) to zero (in Florida), to 10 degrees east (in Texas), meaning a compass adjusted at the beginning of the journey would have a true north error of over 30 degrees if not adjusted for the changing declination.

In most areas, the spatial variation reflects the irregularities of the flows deep in the earth; in some areas, deposits of iron ore or magnetite in the earth's crust may contribute strongly to the declination. Similarly, secular changes to these flows result in slow changes to the field strength and direction at the same point on the Earth. Nonetheless, the magnetic declination in any one location may readily be determined based upon a location and time solution such as that provided by the GPS module 5. The processor module 15 readily retrieves a solution from a look-up table stored in the memory included in the processor module 15 based upon the GPS module 5 and the supplied position and time solution. Correction for declination allows the compass module to correct for true north in three dimensions.

The inclinometer 9 registers inclination relative to two orthogonal axes which is sufficient for determining angular deviation with respect to a horizontal plane. With such a determination, along with an indication from the three-dimensional compass as to the location of magnetic north, corrections can be effected that render a very good orientation of the handheld profiler in real time relative to a three-dimensioned space within the landing zone. Common sensor technologies for inclinometers are accelerometer, Liquid Capacitive, electrolytic, gas bubble in liquid, and pendulum. Any of the common two-axis technologies will serve to orient the handheld profiler 3.

Once an orientation in space relative to the horizon and relative to true north is known, the profiler 3, can, by virtue of the processor module 15, observe and describe the wind vectors in the projected three-dimensioned space relative to cardinal points of a compass. In one embodiment of the profiler 3, three laser optics modules 13 are present in the profiler 3. The profiler 3 can perform its duties with as few as one laser optics module 13 and more than three laser optics modules 13 can provide more data for simultaneous measurement of wind velocity oriented advantageously in distinct directions in order to get still greater redundancy of data. One non-limiting embodiment of the profiler 3, however, advantageously exploits three laser optics modules 13 which are suitably orientable in the three-dimensioned space that the processor module 15 defines relative to the profiler 3. In such a configuration, the three laser optics modules 13 will readily allow a thorough and rapid scan of the three-dimensioned space.

Because the laser optics modules 13 measure the radial component of the air velocity (positive toward the laser optics module 13) as a function of range along the beam, at least two readings are necessary to get a three dimensioned wind vector. In one embodiment, each laser optics module 13 performs a conical scan through a full circle in the azimuth plane at each of three constant elevation angles, thereby to obtain a set of radial components of the air velocity. In the three-dimensioned space, in this non-limiting example, azimuth is measured clockwise from North at a specified time. In operation, this conical scanning method is advantageously repeated many times within a period long enough to sample a number of advecting eddies up to the largest scale of interest in a designated turbulent spectrum. From this scan, the processor module 15 readily models the wind profile within the three-dimensioned space the processor has defined around the landing zone.

In one non-limiting embodiment, the processor simply completes the wind profile and it is the profile that can be readily transmitted to an instrument within the aircraft to determine a suitable location from which to drop a payload based upon drop and sail characteristics of the payload. In another embodiment, the drop and sail characteristics of the payload are stored as a payload drop profile within the processor module 15 and the processor module 15 develops a release solution such that the exact release coordinates can be transmitted to the aircraft without requiring the aircraft to receive the whole of the wind profile. In this second embodiment, coordinates can be “called in” to the aircraft in a manner similar to calling in artillery support on a battlefield. Various additional embodiments are possible which allow ground determination of the wind profile to enable precise selection of coordinates from which to drop the payload.

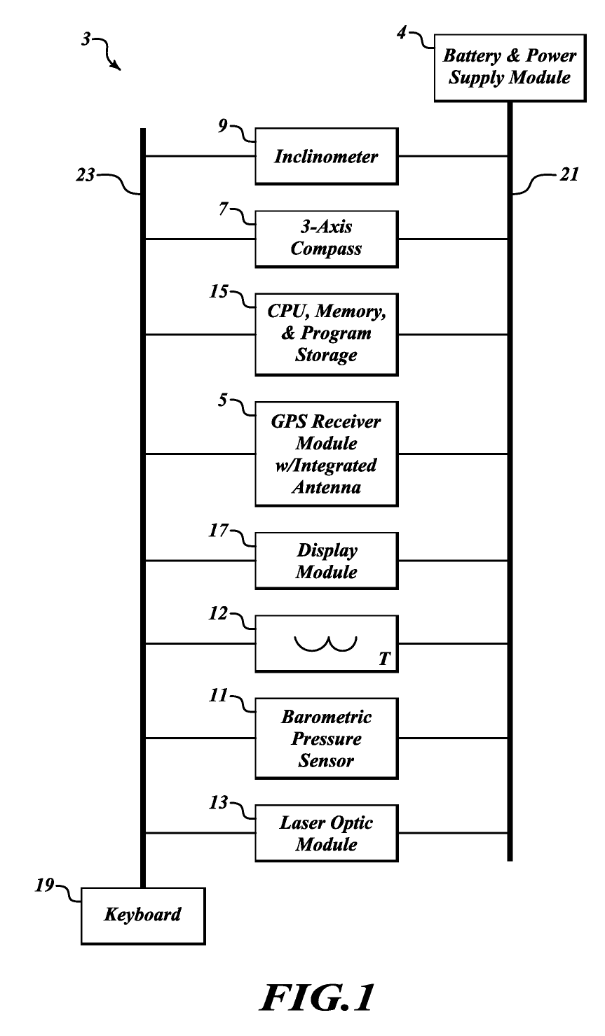

Referring to FIGS. 2a and 2b, one embodiment of the handheld profiler 3 is shown both in front view and cutaway view respectively. A housing 21 contains the profiler 3 which includes the exemplary three laser optics modules 13 rotatably positioned. The GPS Receiver 5 is shown as optionally including an integrated antenna and positioned atop the three laser optics modules 13. The 3-axis compass 7, the two-axis inclinometer 9, and the barometric pressure sensor 11 are arrayed immediately beneath the laser optics modules 13, thereby allowing an optimal packing of the space allowing the sensors to be advantageously placed together allowing routing of both the power bus 21 (FIG. 1) and the data bus 23 (FIG. 2) to allow modular construction of the sensor for ready replacement or updating of the modules.

Beneath the sensors, in the non-limiting embodiment, power is provided by a battery and power supply module (“power module”) 4. As shown in FIG. 2b, the power module may be readily removed and replaced without further disassembly of the profiler 3. To further enable the removal and replacement, the remainder of the profile electronics (the processor module 14, the display 17, and the keyboard 19), are advantageously arrayed to facilitate their use as the user interface. The user interface includes a keyboard 19 and a graphic display 17, located immediately proximate to the processor module 15, the heart of the profiler 3 and facilitating interaction with the processor module 15 through the data bus 23.

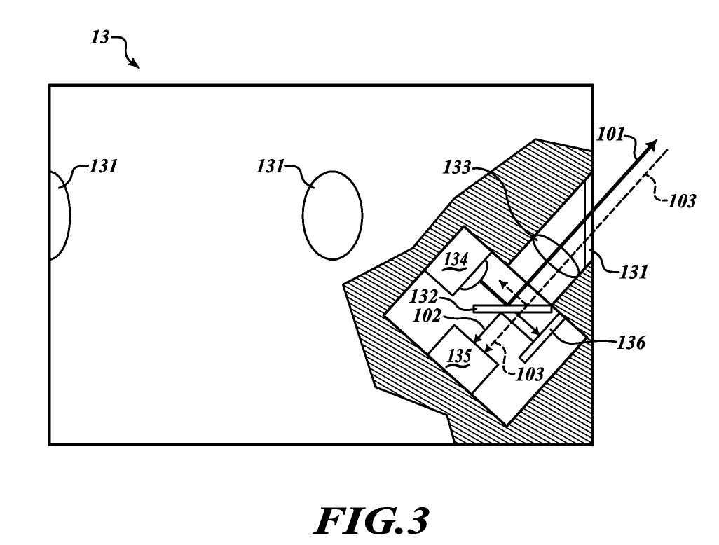

FIG. 3 depicts the non-limiting arrangement of the three laser optics modules 13 as shown by the presence of three Brewster windows 131. Brewster windows are uncoated substrates oriented at Brewster's Angle to an outgoing laser beam 101 (the angle at which only p-polarized light has zero transmission loss). A Brewster window used in a laser cavity will ensure linearly polarized output light allowing easy filtering of the returning beam 103 for interferometry. Additionally, the Brewster's window eliminates interference effects caused by reflections from differently oriented planar windows.

Within the laser optics modules 13 (only one shown for clarity), a source laser diode 134 generates the outgoing laser beam 101, which strikes a half-silvered mirror 132 splitting the beam such that the beam 101 exits through a focusing lens assembly 133 and then the Brewster window 131 described above. The outbound beam 101 is reflected by aerosols within winds in the three-dimensioned space to produce a return beam 103, which re-enters the Brewster window 131 passing through the focusing lens assembly 133 to strike the half-silvered mirror 132. At the half-silvered mirror 132, the returning beam is transmitted to a beam receiver 135. The original beam 101 also passed through the half silvered mirror 132 to strike a fully reflective mirror 136 to again strike the half-silvered mirror 132 to arrive with the inbound beam 103 at the receiver 135, there to create an interference pattern indicative of a radial speed of the aerosol. Thus the laser optics module 13 functions as a laser Doppler velocimeter.

While the preferred embodiment of the invention has been illustrated and described, as noted above, many changes can be made without departing from the spirit and scope of the invention. For example, while a monostatic laser Doppler velocimeter is shown, a bistatic laser Doppler velocimeter might also be advantageously exploited. Bistatic laser optics systems derive their name from having separate transmit and receive optics. Monostatic systems have common transmit and receive optics. Bistatic systems have non-parallel transmit and receive beams that can be arranged to intersect at a certain point, thereby further accurately defining the remote probe volume (i.e., the area in space from which Doppler wind speed measurements are acquired). Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A platform for a handheld wind profiler comprises:
a housing containing:
a three-axis magnetic compass module generating a compass signal including the orientation of the housing relative to magnetic north at a time;
a two-axis inclinometer module generating a inclinometer signal including the orientation of the housing relative to a horizontal plane at the time;
a GPS module generating a GPS signal indicating a time and position solution including a terrain position of the housing based upon the time; and
a processor module to receive a first velocimeter signal at the time from at least one laser Doppler velocimeter, the velocimeter signal including a first radial velocity of a first wind-borne aerosol and a first orientation of the at least one laser Doppler velocimeter relative to the housing, the processor resolving the first velocimeter signal to determine an orientation of the at least one laser Doppler velocimeter relative to the terrain position based upon the first velocimeter signal, the compass signal, the GPS signal, and the inclinometer signal.

2. The platform of claim 1, wherein:
the processor module is further configured to:
receive a second velocimeter signal from the at least one laser Doppler velocimeter indicating a second radial velocity of a second wind borne aerosol; and
resolve the second velocimeter signal to determine a second orientation of the at least one laser Doppler velocimeter relative to the terrain position based upon the second velocimeter signal, the compass signal, the GPS signal, and the inclinometer signal.

3. The platform of claim 2, wherein the processor module is further configured to generate a model of winds sensed by the at least one laser Doppler velocimeter based upon the first velocimeter signal and the orientation of the at least one laser Doppler velocimeter at the first and the second times.

4. The platform of claim 3, wherein the processor module is further configured to determine release coordinates for an aircraft dropping a payload based upon a payload drop profile and the model of the winds.

5. The platform of claim 4, further comprising;
a barometer generating a barometer signal including an air density at the first time; and
the processor module is further configured to determine the release coordinates further based upon the air density.

6. The platform of claim 1, further comprising a user interface including:
a display; and
a keyboard having at least one user-activatable switch to generate a keyboard signal received at the processor module.

7. The platform of claim 6, wherein a touch sensitive screen includes the display and the keyboard.

8. A method for generating a model of winds present in a three-dimensioned space enveloping a housing; the method comprising:
directing at least one laser Doppler velocimeter the housing contains at a wind-borne a first aerosol radially displaced from the housing by a first radius and first angle relative to the housing to determine a radial velocity of the aerosol at a time;
determining a time and position solution within a three-dimensioned terrain volume oriented to true North using a GPS module at the time;
determining a magnetic orientation of the housing relative to magnetic north at a three-axis compass module at the time;
determining a horizontal orientation of the housing relative to a horizontal plane at an inclinometer at the time; and
developing a first radial velocity of the aerosol within the terrain volume based upon the horizontal orientation, the magnetic orientation, the time and position solution at the time, and radius and angle relative to the housing at a processor module.

9. The method of claim 8, further comprising:
directing at least one laser Doppler velocimeter the housing contains at a second wind-borne aerosol radially displaced from the housing by a second radius and second angle relative to the housing to determine a second radial velocity of the aerosol at the time; and
modeling a wind profile of the winds within the volume based upon the first and the second radial velocity.

10. The method of claim 9, further comprising:
determining at least one release point within the volume based upon the wind profile and a payload drop and sail profile.

11. The method of claim 10, further comprising:
retrieving the payload drop and sail profile according to a selected payload from processor module.

12. The method of claim 9, further comprising:
determining an air density at a barometric pressure sensor; and
modeling a wind profile includes modeling a wind profile based upon the air density.

13. The method of claim 10, further comprising:
displaying the release point to a user at a display.

14. The method of claim 8, further comprising:
receiving at the processor module a keyboard signal from a keyboard.

15. A wind profiler for constructing a wind profile, the processor module comprising:
a data bus configured to receive:
a compass signal a three-axis magnetic compass module generates, the compass signal including the orientation of the housing relative to magnetic north at a time;
a inclinometer signal a two-axis inclinometer module generates, the inclinometer signal including the orientation of the housing relative to a horizontal plane at the time;
a GPS signal a GPS module generates, the GPS signal indicating a time and position solution including a terrain position of the housing based upon the time; and
a first velocimeter signal at the time from at least one laser Doppler velocimeter, the velocimeter signal including a first radial velocity of a first wind-borne aerosol and a first orientation of the at least one laser Doppler velocimeter relative to the housing, and
a processor module for resolving the first velocimeter signal to determine an orientation of the at least one laser Doppler velocimeter relative to the terrain position based upon the first velocimeter signal, the compass signal, the GPS signal, and the inclinometer signal.

16. The wind profiler of claim 15, wherein:
the processor is further configured to:
receive a second velocimeter signal from the at least one laser Doppler velocimeter indicating a second radial velocity of a second wind borne aerosol; and
resolve the second velocimeter signal to determine a second orientation of the at least one laser Doppler velocimeter relative to the terrain position based upon the second velocimeter signal, the compass signal, the GPS signal, and the inclinometer signal.

17. The wind profiler of claim 16, wherein
the processor module is further configured to generate a model of winds sensed by the at least one laser Doppler velocimeter based upon the first velocimeter signal and the orientation of the at least one laser Doppler velocimeter at the first and the second times.

18. The wind profiler of claim 17, wherein
the processor module is further configured to determine release coordinates for an aircraft dropping a payload based upon a payload drop profile and the model of the winds.

19. The wind profiler of claim 18, further comprising;
a barometer generating a barometer signal and a temperature sensor generating a temperature to calculate an air density at the first time; and wherein
the processor module is further configured to determine the release coordinates further based upon the air density.

20. The wind profiler of claim 15, further comprising a user interface including:
a display; and
a keyboard having at least one user-activatable switch.
